(19) United States
(12) Patent Application Publication
(10) Pub. No.: US 2008/0109649 A1
(43) Pub. Date: May 8, 2008

(54) Using a reservation to automatically drive configuration management

(76) Inventors: William Brothers, Roseville, CA (US); Noreen Lee, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/582,074

(22) Filed: Oct. 16, 2006

(51) Int. Cl. G06F 1/24

(52) U.S. Cl. 713/100

(57) ABSTRACT

Embodiments of the present invention pertain to using a reservation to automatically driven configuration management. According to one embodiment, a request to reserve a reproduction of a computer environment for a requested period of time is received. The reproduction of the computer environment is automatically created. The reproduction is automatically reserved for the requested period of time.

### TECHNICAL FIELD

Embodiments of the present invention relate to computer environments. More specifically, embodiments of the present invention relate to using a reservation to automatically drive configuration management.

### BACKGROUND ART

Organizations around the world are using computers to automatically perform various activities. Examples of organizations include, among other things, companies and non-profit organizations. These organizations buy hardware, such as computer systems, and software, such as operating systems and applications, to perform these activities. The hardware, the software that executes on the hardware and the configuration of the hardware and software is an example of the organization's “computer environment.” An “image” on a piece of hardware may include software. The image may include the configuration for hardware or software, or a combination thereof.

Invariably at some point in time the organization has a problem with their hardware, their software, their configuration, or a combination thereof. Frequently the organization has to obtain help from the companies they bought the hardware or software from in order to determine what the problem is and to solve the problem.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a block diagram of a computer environment that can be automatically reproduced, according to one embodiment.

FIG. 2 depicts a block diagram of a system that uses a reservation to automatically drive configuration management and repositories that the system uses, according to one embodiment.

FIG. 3 depicts another system for using a reservation to automatically drive configuration management, according to one embodiment.

FIG. 4 depicts a flowchart of a method of using a reservation to automatically drive configuration management, according to one embodiment.

FIG. 5 depicts a flowchart of a method for automatically reproducing a computer environment, according to one embodiment.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, components, and circuits have not been described in detail as not to unnecessarily obscure aspects of the present invention.

### Overview

As already stated, organizations frequently have to obtain help from the companies they bought the hardware or software from in order to determine what the problem is and to solve the problem. In order to determine the problem and to solve the problem, the companies that sold the hardware or software may want to reproduce the computer environment in which the problem is occurring.

A method and a system for using a reservation to automatically drive configuration management are provided, according to one embodiment. For example, a request to reserve a reproduction of a computer environment for a requested period of time is received. A reproduction of the computer system is automatically created and automatically reserved for the requested period of time.

Automatically creating the reproduction of the computer environment involves selecting hardware that is the same type as the organization's hardware and ensuring that the image on the selected hardware is the same type as the organization's image, according to one embodiment. Various embodiments of the present invention can result in reproducing and reserving a computer environment, for example, in as little as an hour and a half.

### Computer Environment

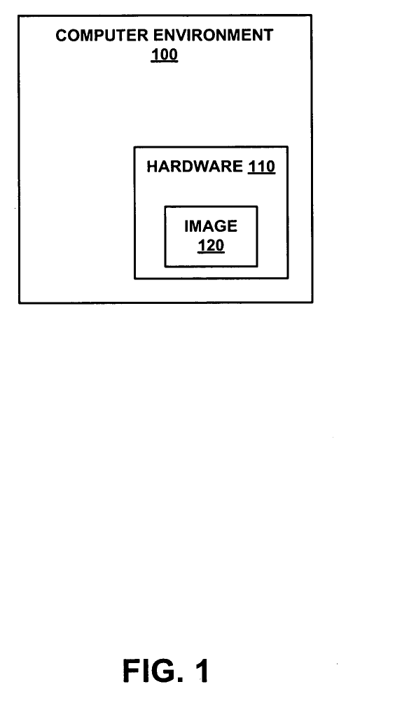

An organization's installation may include 100's even 1000's of pieces of hardware and many different types of images installed on those pieces of hardware. A computer environment may be a subset of the installation that is replicated in order to reproduce some behavior, such as a problem. FIG. 1 depicts a block diagram of a computer environment that can be automatically reproduced, according to one embodiment. Assume for the sake of illustration, that the computer environment 100 is an organization's computer environment. The computer environment, as depicted in FIG. 1, includes a piece of hardware 110 and an image 120 that is installed on that piece of hardware 110. For simplicity, the computer environment 100 is depicted with only one piece of hardware 110 and installed image 120. However, an organization's computer environment 100 may include many pieces of hardware and images installed on each of those pieces of hardware.

### A System that Uses a Reservation to Automatically Drive Configuration Management

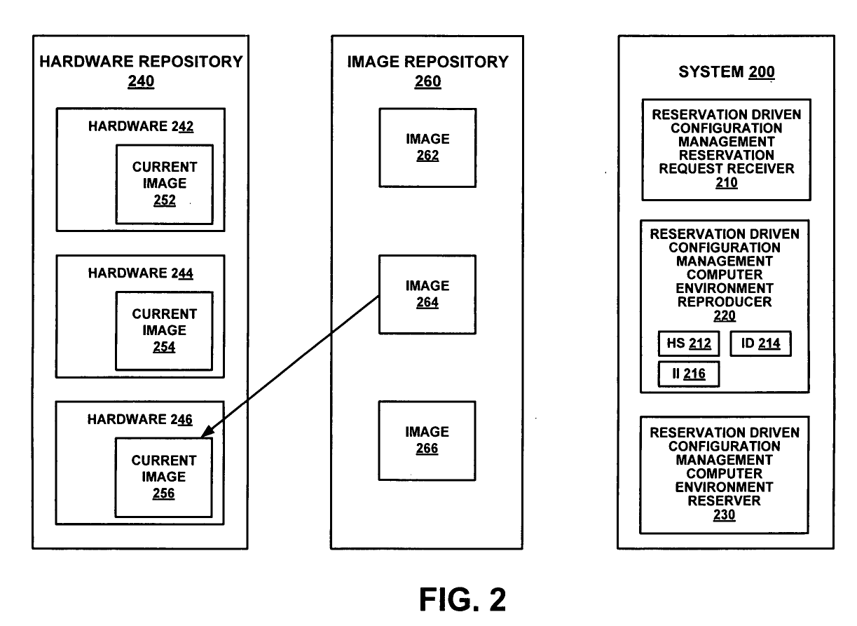

FIG. 2 depicts a block diagram of a system that uses a reservation to automatically drive configuration management and repositories that the system uses, according to one embodiment. The system 200 includes a reservation driven configuration management reservation request receiver 210, a reservation driven configuration management computer environment reproducer 220 and a reservation driven configuration management computer environment reserver 230. The computer environment reproducer 220 includes an automatic computer environment reproducing hardware selector 212, an automatic computer environment reproducing image determiner 214, and an automatic computer environment reproducing image installer 216.

The hardware repository 240 includes pieces of hardware 242, 244, and 246 that are available to be selected by the selector 212. As depicted in FIG. 2, each piece of hardware 242-246 also includes an image 252-256 that is currently installed on that piece of hardware 242-246 (referred to hereinafter as “current image”). However, a piece of hardware associated with the hardware repository 240 does not have to have any software installed on it. The image repository 260 includes images 262-266 that are available to be installed on a piece of hardware 242-246 that is selected from the hardware repository 240.

The reservation request receiver 210 can receive a request to reserve a reproduction of a computer environment for a requested period of time. The request may have been entered by a person. The computer environment reproducer 220 may reproduce the computer environment 100 indicated in the request that the reservation request receiver 210 received. The selector 212 associated with the computer environment reproducer 220, according to one embodiment, automatically selects a piece of hardware, such as hardware 246, that is the same type as the organization's hardware 110 (FIG. 1) from the hardware repository 240. The determiner 214 associated with the computer environment reproducer 220 may determine whether the current image 256 on the selected hardware 246 (FIG. 2) is the same type as the image 120 on the organization's hardware 110 (FIG. 1). If the current image 256 on the selected hardware 246 is not the same type as the organization's image 120, an image, such as image 264 that is the same type, can be selected from the image repository 260.

The system 200 searches the hardware repository 240 for a piece of hardware that matches the computer environment's hardware 110, according to one embodiment. The piece of hardware that is selected can also have a current image that matches the computer environment's image 120. The system 200 can use the selector 212 and the determiner 214 as a part of performing the search. If hardware with a current image that matches the computer environment's hardware 110 and image 120 cannot be found, a piece of appropriate hardware may be selected from the hardware repository 240 and an appropriate image from the image repository 260 is installed on the selected hardware. Assume for the sake of illustration that the system 200 was not able to find a piece of hardware with a current image that matched both the computer environment's hardware 110 and image 120. In this case, assume that hardware 246 is selected because it matches the computer environment's hardware 110. However, a new image 264, which matches the computer environment's image 120, will replace the old current image 256, which does not match the computer environment's image 120.

The installer 216 associated with the computer environment reproducer 220, according to one embodiment, installs the new image 264 selected from the image repository 260 (FIG. 2) on the selected hardware 246. The computer environment reserver 230 can reserve the reproduction of the computer environment for the requested period of time indicated in the request.

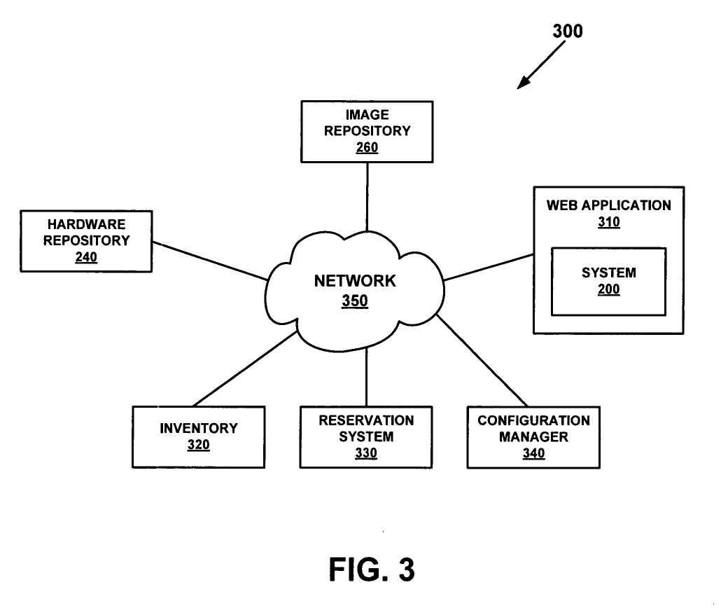

FIG. 3 depicts another system for using a reservation to automatically drive configuration management, according to one embodiment. The system 300 depicts a hardware repository 240, an image repository 260, a web application 310, an inventory 320, a reservation system 330, a configuration manager 340 and a network 350. The web application 310 can include a system 200 as depicted in FIG. 2. A database can be used to implement the inventory 320. The inventory 320 can include information about the pieces of hardware 242-246 associated with the hardware repository 240 and the images 262-266 associated with the image repository 260. The inventory 320 can also include information about the current images 252-256 installed on the pieces of hardware 242-246.

The reservation request receiver 210 associated with the web application 310, according to one embodiment, receives a request to automatically reproduce and reserve a computer environment 100 (FIG. 1). The web application 310 can enable a person to view information from the inventory 320 about hardware 242-246 or images 262-266, to reserve hardware 246 and to cause an image 264 to be installed on the reserved hardware 246. The selector 212 can use the inventory 320 to select a piece of hardware from the hardware repository 240 that is the same type as the computer environment 100's hardware 110. If hardware 246 is selected, the computer environment reserver 230 can interact with the reservation system 330 to reserve the selected hardware 246 for a requested time period. The system 200 (FIG. 2) can also select an image from the image repository 260 that is the same type as the computer environment 100's image 120. If image 264 is selected, the installer 216 can install the selected image 264 on the selected hardware 246. Referring to FIG. 3, according to one embodiment the system 200 interacts with a configuration manager 340 as a part of installing the new image 264 on the selected hardware 246, as will become more evident. In this illustration, the hardware 246 with the image 264 installed on it is an example of a reproduction of a computer environment 100.

The blocks that represent features in FIGS. 1-3 can be arranged differently than as illustrated, and can implement additional or fewer features than what are described herein. Further, the features represented by the blocks in FIGS. 1-3 can be combined in various ways. For example the reservation system 330 can be a part of the web application 310. The systems depicted in FIGS. 1-3 can be implemented using software, hardware, firmware, or a combination thereof.

### Hardware and Images

The hardware repository 240, according to one embodiment, includes many pieces of hardware 242-246 of various types. The pieces of hardware 242-246 can be selected as described herein as a part of automatically reproducing a computer environment 100 (FIG. 1). Examples of types of hardware 242-246 include, but are not limited to, a particular model for a particular manufacturer, the number of central processing units (CPUs), the amount and the types of storage, and so on. Examples of manufacturers include, but are not limited to, Intel™, Dell™, Apple™, Hewlett Packard™ (HP™) and so on.

A type of hardware can be provided by a virtual machine (VM). A virtual machine includes an operating system kernel that simulates the hardware of a particular make and model of computer. For example, a VM may simulate a particular type of Intel™ computer.

An image 262-266 and 252-256 can include an operating system, various applications, an agent, a configuration for the hardware or the software or any combination thereof. An image, which includes an operating system, such as Windows 2003, and various applications can be installed and executed on a VM.

According to one embodiment, the new image 262-266 replaces the current image 252-256. For example, if the selected hardware 246's current image 256 is an operating system that does not match the operating system associated with the computer environment 100's image 120, then the new image 264, which includes the correct operating system, may entirely replace the selected hardware 246's current image 256. According to another embodiment, the new image 264 may replace a part of the selected hardware 246's current image 256. For example, if the operating system associated with the computer environment 100 and the selected hardware 246 are the same type but an application is different, the new image 264 may include a correct application that replaces part of the current image 256. According to yet another embodiment, the new image 264 does not replace any of the current image 256. For example, assume that the computer environment 100's image 120 includes an operating system and an application. Also assume that the selected hardware 246's current image 256 includes the same type of operating system but doesn't include the application. The new image 264, which will be installed on the selected hardware 246, may include the application. In this case, the new current image 256 includes, according to one embodiment, the old current image 256 and the installed new image 264.

More than one new images can be used to create a new current image. For example, one new image may be the desired operating system and another new image may be the desired application. Both of these new images may be installed on the selected hardware to create a current image on the selected hardware.

Once the new image 264 replaces the current image 256, it becomes the current image, according to one embodiment. According to another embodiment, the new image 264 in combination with the previous current image 256 or a part of the previous current image 256 becomes the new current image.

According to one embodiment, “same type” of hardware is not necessarily the exact same make or model of hardware. For example, “same type” of hardware can refer to hardware 242-246 that is capable of reproducing behavior, such as a problem, that is occurring with a computer environment. Similarly “same type” of image can refer to an image 262-266 that is capable of reproducing behavior, such as a problem, that is occurring with a computer environment.

### Inventory

The inventory 320 includes information about the pieces of hardware 242-246 associated with the hardware repository 240 or the images 262-266 associated with the image repository 260 or a combination thereof. The inventory can also include information about the current images 252-256 installed on the hardware 242-246. According to one embodiment, the pieces of hardware associated with the hardware repository have agents installed on them. The agents can communicate information about hardware and software. For example, the agents can communicate information about the hardware in the hardware repository as well as the current images on the hardware.

The inventory can include information about systems that are grouped according to how they are used. For example, the inventory may include information about reproduction systems that will almost never be changed. However, the inventory may be used to maintain and track these reproduction systems. The inventory may also include information about stable systems that can be changed but only after much discussion between various managers. The inventory may also include information about temporary systems that are readily available to be changed. The later are the most likely candidates to be selected for reproducing a computer environment 100 (FIG. 1).

### Web Application

According to one embodiment, the web application 310 either includes or communicates with the system 200. A receiver 210 associated with the web application can receive a request to automatically reproduce a computer environment 100 (FIG. 1). The request may be a user specified request. For example, a person can interact with the web application 310 over a network 350 causing the web application 310 to receive a request. The request can include information pertaining to the hardware 110 and the image 120 that was installed on the hardware for the computer environment 100 that reproduction is requested for. The request can also include a time period (referred to herein as the “requested time period”) to reserve the reproduction of the computer environment.

The web application 310 can enable a person to view information from the inventory 320 about hardware 242-246 or images 262-266, to reserve hardware 246 and to cause an image 264 to be installed on the reserved hardware 246.

### Reserving a Reproduction of a Computer Environment

A reserver 230 can interact with a reservation system 330 to reserve the selected hardware 246 for the requested time period. If no appropriate hardware from the hardware repository 240 is available during the requested time period, the reserver 230 can provide time periods that the selected hardware is available. The time period that the selected hardware is actually reserved for shall be referred to as the “reservation time period”. Time zones can be handled. For example, a situation where two people in two different time zones request the same types of hardware and images for the same time period can be handled. A reservation time period can start immediately. The reproduction can be reserved for shared or exclusive use.

### Configuration Management

Frequently, organizations use configuration managers 340 to ensure that their employee's have consistently configured computer systems. For example, the configuration manager may be set up with a policy that indicates what software and configurations are authorized for the organization's computers. Assume for the sake of illustration that an employee downloads unauthorized software onto their computer system or changes their computer system's configuration in an unauthorized way. The configuration manager periodically checks what software is installed on the computer systems and how the computer systems are configured. If unauthorized software has been installed or if the configuration has been changed in an unauthorized way, the configuration manager is capable of changing the software or configuration so that the computer system is in an authorized state again.

According to one embodiment, the system 200 (FIG. 2) interacts with a configuration manager 340 as a part of installing the new image 264. For example, the system 200 can communicate to the configuration manager 340 what the selected hardware is, what the current image on that hardware is, or what the new image is, among other things. The configuration manager can interact with an agent that resides on the selected hardware as a part of installing the new image 262-266 on the selected hardware. However, if the selected hardware has no software on it, the configuration manager can use commands to install a new image.

According to one embodiment, the configuration manager 340 is a configuration manager associated with HP™'s OpenView Radia Management Suite.

### A Method Using a Reservation to Automatically Drive Configuration Management

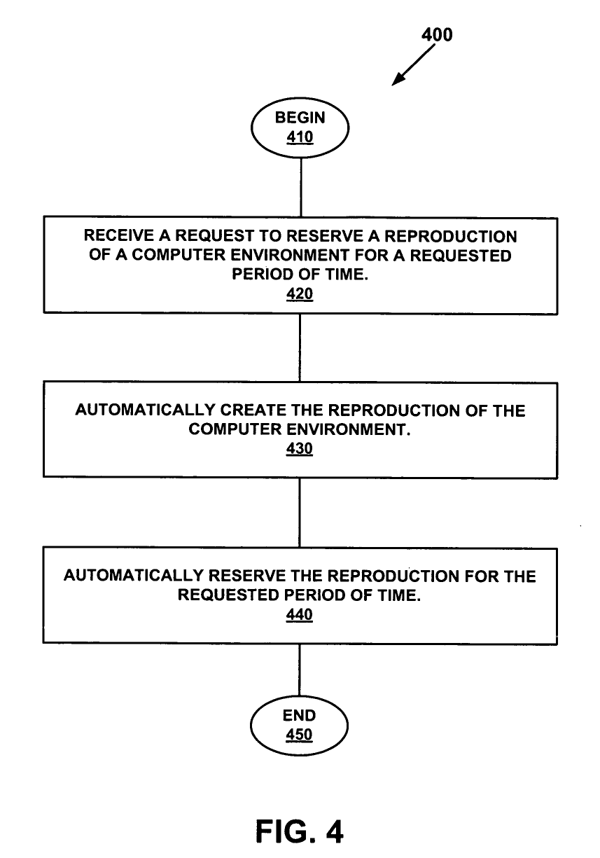

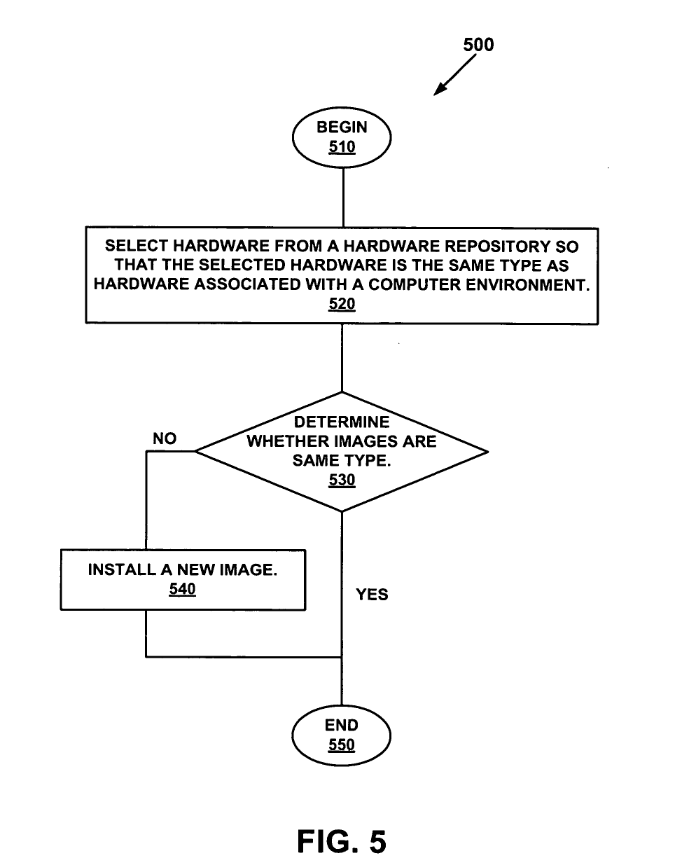

FIG. 4 depicts a flowchart of a method of using a reservation to automatically drive configuration management, according to one embodiment. FIG. 5 depicts a flowchart of a method for automatically reproducing a computer environment, according to one embodiment. Although specific steps are disclosed in flowcharts 400 and 500, such steps are exemplary. That is, embodiments of the present invention are well suited to performing various other steps or variations of the steps recited in flowcharts 400 and 500. It is appreciated that the steps in flowcharts 400 and 500 may be performed in an order different than presented, and that not all of the steps in flowcharts 400 and 500 may be performed.

All of, or a portion of, the embodiments described by flowcharts 400 and 500 can be implemented using computer-readable and computer-executable instructions which reside, for example, in computer-usable media of a computer system or like device. As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

Refer to FIGS. 1 and 3 for the following description of flowcharts 400 and 500. Assume for the sake of illustration that hardware 246 will be selected and that image 264 will be installed on hardware 246.

In step 410, the method of using a reservation to automatically drive configuration management begins.

In step 420, a request to reserve a reproduction of a computer environment for a requested period of time is received. For example, the receiver 210 associated with a web application 310 receives a request to automatically reproduce a computer environment 100 (FIG. 1) for example that a person has entered. The request can include information pertaining to the computer environment's hardware 110, the image 120 that was installed on the computer environment's hardware 110 that reproduction is requested for, and a time period (referred to herein as the “requested time period”) to reserve the reproduction of the computer environment 100. For example, the requested time period may be 4 hours

In step 430, the reproduction of the computer environment is automatically created. The flowchart 500 according to one embodiment provides a description of automatically creating the reproduction of the computer environment, according to one embodiment. In step 510, the method of automatically creating the reproduction of the computer environment begins.

In step 520, hardware is selected from a hardware repository so that the selected hardware is the same type as hardware associated with the computer environment. According to one embodiment, a database is used to implement an inventory 320. The inventory 320 can include information about the pieces of hardware 242-246 associated with the hardware repository 240 and the images 262-266 associated with the image repository 260. The inventory 320 can also include information about the current images 252-256 installed on the hardware 242-246. An agent can be used to communicate information about the hardware 242-246 in the hardware repository 240, including the current images 252-256.

The selector 212 can use the inventory 320 to select a piece of hardware from the hardware repository 240 that is the same type as the computer environment's hardware 110. For example, assume that hardware 246 is selected.

In step 530, a determination is made as to whether a current image that is installed on the selected hardware is the same type as an image installed on the hardware associated with the computer environment. For example, the determiner 214 can determine if the current image 256 is the same type as the computer environment's image 120. According to one embodiment, the determination is made shortly before the reservation time period starts. Assume for the sake of illustration that a determination is made that the current image 256 is not the same type as the computer environment's hardware's image 120.

In step 540, if the images are not the same type, a new image is installed onto the selected hardware. If the images 256 and 120 (the current image 256 and the computer environment's image 120) are not the same type, a new image can be installed onto the selected hardware 246. Assume for the sake of illustration that the new image 264 is the same type as the computer environment's image 120 and therefore the new image 264 is selected to be installed on the selected hardware 246. The system 200 can select a new image 264 from the image repository 260 and the installer 216 can install the new image 264 on the selected hardware 246.

The reproducer 220 can communicate to the configuration manager 340 that hardware 246 was selected and that new image 264 was selected, among other things. The configuration manager 340 can be used as a part of installing the new image 264 onto the selected hardware 246. The configuration manager 340 can interact with an agent that resides on the selected hardware 246 as a part of installing the new image 264. However, if the hardware 246 has no software on it, the configuration manager 340 can use commands to install the new image 264 on the selected hardware 246.

If there is no current image installed on the selected hardware, according to one embodiment, this is treated as if there isn't a match between the computing environment's image and the selected hardware's image and therefore an image is selected from the image repository and installed on the selected hardware.

In step 550, the method stops.

In step 440, the reproduction is automatically reserved during the requested period of time. For example, in this illustration hardware 246 with image 264 installed as the current image 256 can be reserved for the requested time period of 4 hours.

In step 450, the method ends.

Although the above illustration of flowcharts 400 and 500 assumed that the current image 256 installed on the hardware 246 did not match the computer environment's image 120, embodiments of the present invention can work just as well when the current image 256 does match the image 120. For example, according to one embodiment, selecting a piece of hardware with a current image that matches a computer environment's hardware 110 and image 120 from the hardware repository is an example of reproducing the computer environment. More specifically, if the selected hardware 246 matched the computer environment's hardware 110 and the current image 256 matched the computer environment's image 120, then selecting hardware 246 and its current image 256 is an example of creating a reproduction, according to one embodiment.

Although many of the illustrations described herein pertain to companies that sell hardware and software reproducing computer environments for their clients, various embodiments can also be used by software development organizations. For example, software development organizations can use a system 200 or 300 to set up a variety of hardware and software configurations to test their applications that they are developing.

What is claimed is:

1. A computer implemented method of using a reservation to automatically drive configuration management, the method comprising:
receiving a request to reserve a reproduction of a computer environment for a requested period of time;
automatically creating the reproduction of the computer environment; and
automatically reserving the reproduction for the requested period of time.

2. The computer implemented method as recited by claim 1,
wherein the automatically creating of the reproduction further comprises:
automatically selecting hardware from a hardware repository so that the selected hardware is the same type as hardware associated with the computer environment.

3. The computer implemented method as recited by claim 2, further comprising:
storing information in an inventory about pieces of hardware that can be selected and images that can be installed.

4. The computer implemented method as recited by claim 3, further comprising:
receiving the information from at least one of the pieces of hardware from an agent that is installed on the at least one piece of hardware.

5. The computer implemented method as recited by claim 1,
wherein the automatically creating of the reproduction further comprises:
selecting a new image from a repository of images; and
automatically installing the new image on selected hardware.

6. The computer implemented method as recited by claim 5,
wherein the automatically selecting of the new image further comprises:
automatically selecting the new image, wherein the new image is selected from a group consisting of an operating system, an application, a configuration of hardware, a virtual machine kernel, and a configuration of software.

7. The computer implemented method as recited by claim 1, further comprising:
automatically determining if a current image that is installed on selected hardware is the same type as an image installed on hardware associated with the computer environment; and
if the images are not the same type, automatically installing a new image onto the selected hardware, wherein the new image is the same type as the image installed on the hardware associated with the computer environment.

8. A system for automatically reproducing a computer environment, the system comprising:
a reservation driven configuration management reservation request receiver configured for receiving a request to reserve a reproduction of a computer environment for a requested period of time;
a reservation driven configuration management computer environment reproducer configured for automatically creating the reproduction of the computer environment; and
a reservation driven configuration management computer environment reserver configured for automatically reserving the reproduction for the requested period of time, wherein the reservation driven configuration management reservation request receiver is coupled to the reservation driven configuration management computer environment reproducer and the reservation driven configuration management computer environment reproducer is coupled to the reservation driven configuration management computer environment reserver.

9. The system of claim 8, further comprising:
an automatic computer environment reproducing hardware selector configured for automatically selecting hardware from a hardware repository so that the selected hardware is the same type as hardware associated with the computer environment.

10. The system of claim 9, wherein an agent resides on the selected hardware and wherein the agent provides information that is used as a part of the selecting of the selected hardware.

11. The system of claim 8, further comprising:
an automatic computer environment reproducing image determiner configured for automatically determining if a current image that is installed on selected hardware is the same type as an image installed on hardware associated with the computer environment.

12. The system of claim 8, further comprising:
an automatic computer environment reproducing image installer configured for automatically installing a new image onto selected hardware in the event that a current image associated with the selected hardware and an image associated with the computer environment are not the same type, wherein the new image is the same type as the image installed on the hardware associated with the computer environment.

13. The system of claim 12, wherein the system further comprises:
a configuration manager that is used as a part of installing the new image.

14. A computer-usable medium having computer-readable program code embodied therein for causing a computer system to perform a method of using a reservation to automatically driven configuration management, the method comprising:
receiving a request to reserve a reproduction of a computer environment for a requested period of time;
automatically creating the reproduction of the computer environment; and
automatically reserving the reproduction for the requested period of time.

15. The computer-usable medium of claim 14 wherein the computer-readable program code embodied therein causes a computer system to perform the method, and wherein the automatically creating of the reproduction further comprises:
automatically selecting hardware from a hardware repository so that the selected hardware is the same type as hardware associated with the computer environment.

16. The computer-usable medium of claim 15, wherein the computer-readable program code embodied therein causes a computer system to perform the method, and wherein the automatically creating of the reproduction further comprises:
storing information in an inventory about pieces of hardware that can be selected and images that can be installed.

17. The computer-usable medium of claim 14, wherein the computer-readable program code embodied therein causes a computer system to perform the method, and wherein the automatically creating of the reproduction further comprises:
automatically determining if a current image that is installed on selected hardware is the same type as an image installed on hardware associated with the computer environment.

18. The computer-usable medium of claim 17, wherein the computer-readable program code embodied therein causes a computer system to perform the method, and wherein the method further comprises:
if the images are not the same type, automatically installing a new image onto the selected hardware, wherein the new image is the same type as the image installed on the hardware associated with the computer environment.

19. The computer-usable medium of claim 14, wherein the computer-readable program code embodied therein causes a computer system to perform the method, and wherein:
the receiving of the request further comprises receiving a user specified period of time as a part of the request; and
the automatically reserving of the reproduction further comprises automatically reserving the reproduction for the user specified period of time.

20. The computer-usable medium of claim 14, wherein the computer-readable program code embodied therein causes a computer system to perform the method, and wherein the method further comprises:
automatically selecting a virtual machine from the hardware repository so that the selected virtual machine simulates hardware associated with the computer environment.
